(19) United States
(12) Patent Application Publication
(10) Pub. No.: US 2026/0025334 A1
(43) Pub. Date: Jan. 22, 2026

(54) Agentless Traffic Inspection for Application Security

(71) Applicant: Palo Alto Networks (Israel Analytics) Ltd., Tel Aviv (IL)

(72) Inventors: Elad Shuster, Petach Tikva (IL); Shachar Tal, Kfar Saba (IL); Or Berkovitch, Hod Hasharon (IL); Elad Wexler, Ramat Gan (IL)

(21) Appl. No.: 18/776,511

(22) Filed: Jul. 18, 2024

(51) Int. Cl. H04L 45/76; H04L 45/74

(52) U.S. Cl. CPC H04L 45/76; H04L 45/74

(57) ABSTRACT

An apparatus includes a physical network adapter and one or more processors. The physical network adapter is configured to communicate over a network. The one or more processors are configured to host a Virtual Machine (VM) that runs software processes, to run a network stack of the VM, the network stack enabling the software processes to communicate network traffic over the network via the physical network adapter, to program the network stack to mirror at least a selected part of the network traffic of one or more of the software processes, and, using the programmed network stack, to mirror at least the selected part of the network traffic for inspection.

### FIELD OF THE INVENTION

The present invention relates generally to cyber security, and particularly to methods and systems for agentless traffic inspection.

### BACKGROUND OF THE INVENTION

Protection against security hazards in a computer system typically involves inspecting network traffic that is communicated by the various nodes of the system. Selected traffic may be forwarded, for example, to a local or remote analyzer for automated inspection.

### SUMMARY OF THE INVENTION

An embodiment of the present invention that is described herein provides an apparatus including a physical network adapter and one or more processors. The physical network adapter is configured to communicate over a network. The one or more processors are configured to host a Virtual Machine (VM) that runs software processes, to run a network stack of the VM, the network stack enabling the software processes to communicate network traffic over the network via the physical network adapter, to program the network stack to mirror at least a selected part of the network traffic of one or more of the software processes, and, using the programmed network stack, to mirror at least the selected part of the network traffic for inspection.

In some embodiments, the one or more processors are configured to receive an instruction indicating a selection of the one or more software processes to be inspected, and to program the network stack of the VM responsively to the instruction. In some embodiments, the one or more processors are configured to establish a network tunnel that connects the VM to a remote computer, and to mirror at least the selected part of the network traffic via the network tunnel.

In an embodiment, the one or more processors are configured to mirror at least the selected part of the network traffic via the physical network adapter. In another embodiment, the apparatus further includes an additional physical network adapter, and the one or more processors are configured to mirror at least the selected part of the network traffic via the additional physical network adapter.

In a disclosed embodiment, the network stack includes (i) a virtual network adapter and (ii) mirroring software that is intermediate between the virtual network adapter and the physical network adapter, and the one or more processors are configured to program the mirroring software to mirror at least the selected part of the network traffic.

In an embodiment, the selected part of the network traffic includes local traffic communicated between the VM and another VM hosted by the one or more processors. Additionally, or alternatively, the selected part of the network traffic includes remote traffic communicated between the VM and a destination outside the apparatus.

There is additionally provided, in accordance with an embodiment of the present invention, a method including hosting, on a physical computer, a Virtual Machine (VM) that runs software processes.

A network stack of the VM is run in the physical computer, enabling the software processes to communicate network traffic over a network via a physical network adapter. The network stack is programmed to mirror at least a selected part of the network traffic of one or more of the software processes. At least the selected part of the network traffic is mirrored for inspection using the programmed network stack.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer that uses agentless mirroring for network traffic inspection, in accordance with an embodiment of the present invention;

FIG. 2 is a flow chart that schematically illustrates a method for agentless mirroring of network traffic, in accordance with an embodiment of the present invention; and

FIG. 3 is a diagram that schematically illustrates mirroring of received and transmitted packets in the computer of FIG. 1, in accordance with an embodiment of the present invention.

### DETAILED DESCRIPTION OF EMBODIMENTS

### Overview

Various techniques can be used for monitoring and inspecting network traffic of nodes in a computer system, in order to detect and mitigate security hazards.

One possible solution is to install a software agent on every node, and use the agent to mirror selected network traffic from the node for analysis. Such an agent would operate as a proxy, to which all node traffic is redirected, and would therefore become a bottleneck. Moreover, in various use-cases the use of agents for mirroring traffic is problematic or infeasible. For example, some organizations object to installation of third-party agents on their system nodes. The objection may be due, for example, to the high security privileges that need to be granted to the agents, or to the computational and memory overhead the agents require.

Another possible solution, offered by some cloud providers, is node-level traffic mirroring. This solution, however, is expensive, and also limited in granularity to an entire node.

Embodiments of the present invention that are described herein provide improved methods and systems for inspecting network traffic of Virtual Machines (VMs) in virtualized environments, e.g., in cloud-based computer systems. The disclosed techniques perform mirroring from within the network stack of a VM, without requiring any sort of permanent agent.

In some embodiments, a physical computer, e.g., a server of a Cloud Service Provider (CSP), hosts one or more VMs. The hosting physical computer comprises a physical network adapter and one or more processors. For simplicity, the description that follows refers to a single processor by way of example. The physical network adapter connects the computer to a network, e.g., to the Internet. The processor hosts the VMs and performs other processing tasks.

Consider a given VM hosted on the physical computer. The VM runs an Operating System (OS), commonly referred to as a guest OS, and various software processes. In the embodiments described herein, the guest OS is Linux, and the software processes are managed in Kubernetes pods. Each pod may comprise one or more processes that are managed jointly. In alternative embodiments, any other suitable OS and process management environment can be used.

Some of the software processes of the VM may require network access. Among other tasks, the guest OS runs a network stack that enables the various software processes of the VM to communicate network traffic over the network via one or more physical network adapters. The network stack may implement communication protocols such as, for example, Transmission Control Protocol (TCP), TCP over Internet Protocol (TCP/IP) and Ethernet.

In some embodiments, the guest OS of the VM comprises a mirroring management process that is dedicated to management of mirroring operations. In addition, the network stack in the guest OS comprises a programmable mirroring module that mirrors selected network traffic for inspection. The selection of network traffic for inspection may involve selection of specific processes, applications or pods, as well as selection of specific filtered portions of the traffic of a certain process, application or pod. In the present context, the term “mirroring” means creating a duplicate copy of the selected network traffic and sending the duplicate copy to a specified destination over the network. In the embodiments described herein, the destination of the mirrored traffic is an observer node, also referred to as “sensor” or “analyzer”. Alternatively, however, any other suitable destination can be used.

In a typical implementation, the mirroring management process sends to the mirroring module an instruction indicating one or more selected pods whose traffic should be inspected. In response to the instruction, the mirroring module begins to mirror some or all of the network traffic communicated (sent and received) by the selected pods. The instruction may also specify, possibly per pod, which parts of the network traffic of the pod should be mirrored.

The network traffic selected for mirroring typically comprises a series of packets. In some embodiments, the mirroring module mirrors the packets over a network tunnel that is established between the VM and the analyzer node. The guest OS of the VM typically comprises a “tunnel endpoint”—A software module that encapsulates each packet with a suitable tunnel header and sends the encapsulated packet to the network. The tunnel header typically comprises fields that specify the actual source IP address of the pod and the actual destination IP address of the packet. Therefore, by examining this header, the analyzer may determine the original packet.

Encapsulation may be performed using known tunneling schemes, e.g., Virtual Extensible Local-Area Network (VXLAN) or Generic Network Virtualization Encapsulation (GENEVE), or using a suitable proprietary scheme. When using VXLAN, for example, the encapsulation header also comprises a Virtual LAN identifier (VLAN ID) or Virtual Network Identifier (VNI), which the analyzer can use for correlating received tunneled packets against a known context.

By mirroring the network traffic within the network stack of the VM's guest OS, the disclosed techniques can select traffic for inspection with fine granularity, e.g., of individual pods or processes. The traffic being mirrored may comprise local traffic (communicated between the VM and another VM hosted on the same physical computer) and/or remote traffic (communicated between the VM and a destination outside the physical computer). In comparison with agent-based mirroring techniques, the disclosed techniques incur minimal computational overhead and have a minimal memory footprint.

In some embodiments, the mirroring management process is implemented as a dedicated ephemeral pod having administrator privileges. This pod can be set-up when needed and later destroyed, thereby providing improved security and privacy.

The disclosed techniques are highly effective, for example, in public cloud environments. In a public cloud, the same physical computer may host VMs belonging to multiple different tenants, with strict isolation requirements. When using the disclosed techniques, the mirroring module is loaded as part of the image of the VM's guest OS (and not, for example, as part of the CSP's hypervisor). The disclosed techniques can therefore be deployed exclusively by a given tenant, without requiring any cooperation or coordination on the part of the CSP.

### System Description

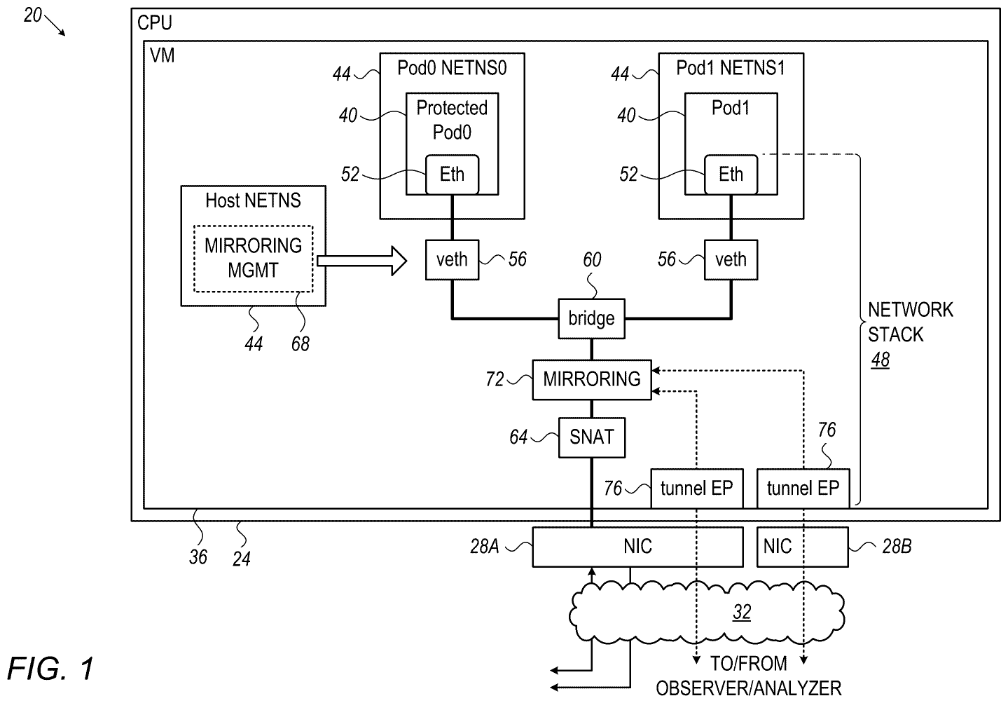

FIG. 1 is a block diagram that schematically illustrates a physical computer 20 that uses agentless mirroring for network traffic inspection, in accordance with an embodiment of the present invention. Computer 20 may comprise, for example, a server in a cloud-based system or a data center, or any other suitable computer.

In the present example, computer 20 comprises a Central Processing Unit (CPU) 24, a physical Network Interface Controller (NIC) 28A, and optionally an additional physical NIC 28B. CPU 24 is considered a non-limiting example of a processor. NICs 28A and 28B are considered non-limiting examples of physical network adapters. Alternatively, computer 20 may comprise one or more processors of any other suitable type, and one or more network adapters of any other suitable types.

NIC 28A is used for connecting computer 20 to a packet network, e.g., to the Internet. In some embodiments, NIC 28A also serves for mirroring network traffic using the disclosed techniques. In such embodiments, NIC 28B may be omitted. In other embodiments, mirrored traffic is sent over network 32 via NIC 28B, e.g., in order not to degrade the available bandwidth of NIC 28A.

Computer 20 hosts one or more Virtual Machines (VMs) 36. FIG. 1 shows only a single VM for the sake of clarity. In real-life scenarios, computer 20 typically hosts multiple VMs. Typically, computer 20 runs a hypervisor (not seen in the figure) that allocates resources of the computer to the various VMs.

VM 36 runs a guest OS, in the present example Linux. The guest OS runs multiple software processes that are managed in pods 40. Each pod 40 runs in a respective network namespace (NETNS) 44.

For communicating over network 32, the guest OS of VM 36 runs a network stack 48. Network stack 48 comprises the following components:
A respective virtual network adapter (“virtual NIC”) 52 and a respective virtual Ethernet device (“veth”) 56 for each pod 40 that requires network access.
An optional virtual Ethernet bridge 60.
A programmable mirroring module 72.
An optional Source Network Address Translation module (SNAT) 64.
A tunnel endpoint (EP) 76.

Mirroring module 72 is responsible for mirroring network traffic of selected pods 40 for inspection. As seen in the figure, module 72 is located in network stack 48, between virtual NICs 52 and physical NIC 28A. Mirroring module 72 is programmable in the sense that it can be configured to receive an instruction to mirror the traffic of one or more selected pods 40 that are chosen for protection. In the example of FIG. 1, the pod labeled “Pod0” is to be protected, while the pod labeled “Pod1” is not.

In some embodiments, the instruction also specifies (possibly per pod) which parts of the pod traffic are to be mirrored. The mirroring module may be instructed, for example, to mirror specific ports, to filter-out certain ports, to mirror specific protocols, to filter-out certain protocols, or otherwise select any other suitable parts of the traffic of the selected pods. In one example embodiment, the instruction instructs mirroring module 72 to refrain from mirroring User Datagram Protocol (UDP) packets, Address Resolution Protocol (ARP) packets and/or Internet Control Message Protocol (ICMP) packets, to reduce the load on the system. In other embodiments, mirroring module 72 may be pre-programmed to specify which parts of the traffic to mirror. Further alternatively, mirroring module 72 may mirror all the traffic of the selected pod or pods.

In various embodiments, mirroring module 72 can be programmed by any suitable entity. In the example of FIG. 1, the guest OS of VM 36 runs a mirroring management module 68. Module 68 may be implemented as a standalone pod that runs in a separate NETNS 44. Mirroring management module 68 is responsible for programming (i.e., sending instructions to) network stack 48.

Once programmed, mirroring module 72 mirrors the specified network traffic and sends the mirrored traffic to tunnel EP 76. Thus, tunnel EP 76 typically receives from module 72 a sequence of packets that need to be sent over a tunnel via network 32 to an analyzer/observer (not seen in the figure). EP 76 encapsulates the packets with suitable tunnel headers and sends the encapsulated packets via NIC 28A or 28B to network 32. In some embodiments, mirroring module 72 is configured to prevent infinite loops, which may be caused by infinite duplication of traffic that goes in and out of physical NIC 28A.

The analyzer/observer typically comprises a peer tunnel EP that de-capsulates the packets and provides them for inspection. The analyzer/observer may perform any suitable processing on the mirrored packets, apply various security checks, Application Programming Interface (API) discovery, analysis, risk assessment, etc.

In some embodiments, both normal network traffic and mirrored traffic are sent via NIC 28A (in which case NIC 28B and the corresponding tunnel EP 76 can be omitted). In other embodiments, NIC 28B is dedicated for mirrored traffic, while NIC 28A is dedicated for normal traffic. In these embodiments, tunnel EP 76 connected to NIC 28A can be omitted.

The configuration of computer 20 shown in FIG. 1 is an example configuration, which is chosen purely for the sake of conceptual clarity. In alternative embodiments, any other suitable configuration can be used.

The various elements of computer 20 may be implemented in hardware, e.g., in one or more Application-Specific Integrated Circuits (ASICs) or Field-Programmable Gate Arrays (FPGAs), in software, or using a combination of hardware and software elements.

CPU 24 may comprise one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

### Agentless Mirroring of Network Traffic

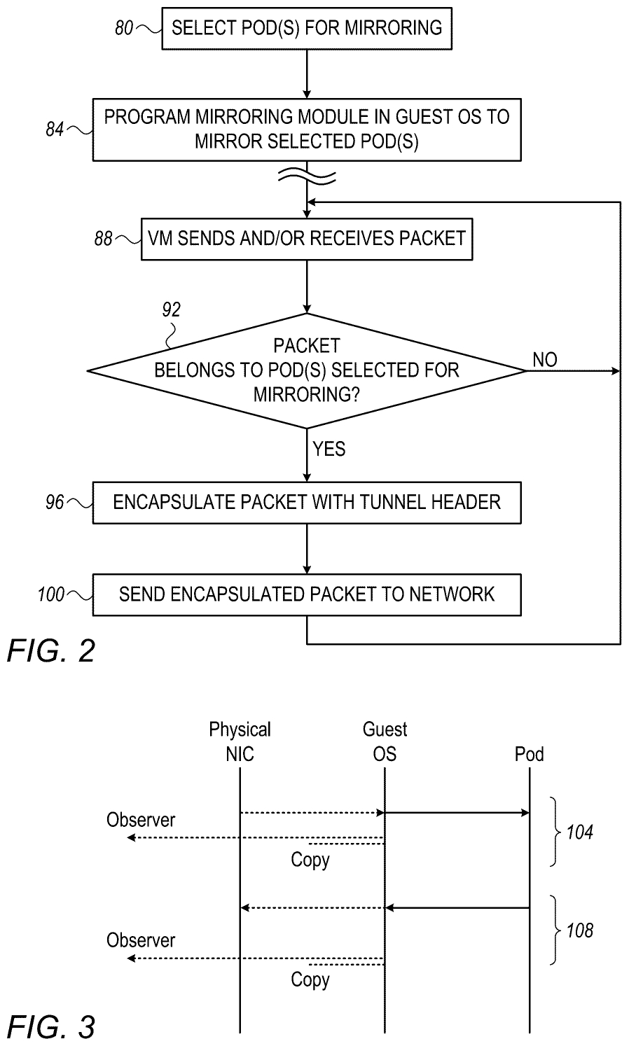

FIG. 2 is a flow chart that schematically illustrates a method for agentless mirroring of network traffic, in accordance with an embodiment of the present invention. The method begins with mirroring management module 68 selecting one or more pods for mirroring, at a pod selection stage 80. The selection may be based, for example, on explicit user input or on any other factor. At a mirroring configuration stage 84, mirroring management module 68 programs mirroring module 72 with the selected pods. From this point mirroring may begin.

At a communication stage 88, VM 36 sends or receives a packet. At a mirroring checking stage 92, mirroring module 72 checks whether the packet belongs to any of the pods 40 that were selected for mirroring. Within the traffic of a selected pod, module 72 may check whether the packet is of a type that should be mirrored (e.g., associated with a specified port, protocol, etc.) If not, the method loops back to stage 88 above.

If the packet belongs to a pod and traffic type that needs to be mirrored, mirroring module 72 duplicates (mirrors) the packet and sends the mirrored packet to tunnel EP 76. Tunnel EP 76 encapsulates the packet with a tunnel header, at an encapsulation stage 96. Tunnel EP 76 sends the encapsulated packet to network 32 via the physical NIC (NIC 28A or 28B as applicable). The network routes the packet in accordance with the tunnel header, to the analyzer/observer. The method then loops back to stage 88 above.

FIG. 3 is a diagram that schematically illustrates mirroring of received and transmitted packets in computer 20, in accordance with an embodiment of the present invention.

The top of the figure (labeled 104) shows the mirroring of a received packet that is addressed to a certain pod 40 in a certain VM 36. As seen, the packet is received from the network by physical NIC 28A. The physical NIC transfers the packet to the guest OS of the VM. The guest OS transfers the packet to the appropriate pod. In addition, the network stack of the VM mirrors the packet and sends the mirrored copy of the packet back to the physical NIC, for sending to the analyzer/observer.

The bottom of the figure (labeled 108) shows the mirroring of a transmitted packet that originates from a certain pod 40 in a certain VM 36. As seen, the pod sends the packet to the guest OS, which in turn sends the packet to the physical NIC. The physical NIC sends the packet over network 32 to its intended destination. In addition, the network stack of the VM mirrors the packet and sends the mirrored copy of the packet back to the physical NIC, for sending to the analyzer/observer.

The example of FIG. 3 demonstrates the small number of copy operations involved in the mirroring process. In some embodiments, the mirroring process requires zero copying of the packet payload. In other words, once the payload is stored in memory, e.g., on arrival from the network (for a received packet) or from the VM (for a transmitted packet), both normal reception/transmission and mirroring use the same stored payload without additional copying or movement.

Although the embodiments described herein mainly address mirroring of pods in a Linux guest OS, the methods and systems described herein can also be used for mirroring of traffic with any suitable granularity and in any other suitable OS. Thus, the term “software process” is regarded herein as encompassing, for example, a selected application, a selected service, etc.

In some embodiments, mirroring module 72 can also be used for enforcing rules or otherwise responding to detected security hazards. For example, in response to detecting that a certain pod is compromised by malware, mirroring module 72 can be instructed to cut-off the network traffic of this pod, block a certain port or protocol, terminate a certain process, elevate a current forensic collection level, or take any other suitable action. Additionally, or alternatively, mirroring module 72 can also be used for detecting anomalies in the traffic, which may be indicative of security hazards. An anomaly may comprise, for example, an increase in traffic volume either into or out of the physical NIC, changes in packet structure, changes in IP-address and/or port distributions, to name only a few examples.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An apparatus, comprising:
a physical network adapter, configured to communicate over a network; and
one or more processors, configured to:
host a Virtual Machine (VM) that runs software processes;
run a network stack of the VM, the network stack enabling the software processes to communicate network traffic over the network via the physical network adapter;
program the network stack to mirror at least a selected part of the network traffic of one or more of the software processes; and
using the programmed network stack, mirror at least the selected part of the network traffic for inspection.

2. The apparatus according to claim 1, wherein the one or more processors are configured to receive an instruction indicating a selection of the one or more software processes to be inspected, and to program the network stack of the VM responsively to the instruction.

3. The apparatus according to claim 1, wherein the one or more processors are configured to establish a network tunnel that connects the VM to a remote computer, and to mirror at least the selected part of the network traffic via the network tunnel.

4. The apparatus according to claim 1, wherein the one or more processors are configured to mirror at least the selected part of the network traffic via the physical network adapter.

5. The apparatus according to claim 1, further comprising an additional physical network adapter, wherein the one or more processors are configured to mirror at least the selected part of the network traffic via the additional physical network adapter.

6. The apparatus according to claim 1, wherein:
the network stack comprises (i) a virtual network adapter and (ii) mirroring software that is intermediate between the virtual network adapter and the physical network adapter; and
the one or more processors are configured to program the mirroring software to mirror at least the selected part of the network traffic.

7. The apparatus according to claim 1, wherein the selected part of the network traffic comprises local traffic communicated between the VM and another VM hosted by the one or more processors.

8. The apparatus according to claim 1, wherein the selected part of the network traffic comprises remote traffic communicated between the VM and a destination outside the apparatus.

9. A method, comprising:
hosting, on a physical computer, a Virtual Machine (VM) that runs software processes;
running in the physical computer a network stack of the VM, the network stack enabling the software processes to communicate network traffic over a network via a physical network adapter;
programming the network stack to mirror at least a selected part of the network traffic of one or more of the software processes; and
using the programmed network stack, mirroring at least the selected part of the network traffic for inspection.

10. The method according to claim 9, wherein programming the network stack comprises receiving an instruction indicating a selection of the one or more software processes to be inspected, and programming the network stack of the VM responsively to the instruction.

11. The method according to claim 9, wherein mirroring at least the selected part of the network traffic comprises establishing a network tunnel that connects the VM to a remote computer, and mirroring at least the selected part of the network traffic via the network tunnel.

12. The method according to claim 9, wherein mirroring at least the selected part of the network traffic comprises mirroring at least the selected part of the network traffic via the physical network adapter.

13. The method according to claim 9, wherein mirroring at least the selected part of the network traffic comprises mirroring at least the selected part of the network traffic via an additional physical network adapter.

14. The method according to claim 9, wherein:
the network stack comprises (i) a virtual network adapter and (ii) mirroring software that is intermediate between the virtual network adapter and the physical network adapter; and
programming the network stack comprises programming the mirroring software to mirror at least the selected part of the network traffic.

15. The method according to claim 9, wherein the selected part of the network traffic comprises local traffic communicated between the VM and another VM hosted in the physical computer.

16. The method according to claim 9, wherein the selected part of the network traffic comprises remote traffic communicated between the VM and a destination outside the physical computer.
